(19) United States
(12) Patent Application Publication
(10) Pub. No.: US 2007/0158480 A1
(43) Pub. Date: Jul. 12, 2007

(54) Flavoring container

(76) Inventor: Tsung Po Yao, Kaohsiung City (TW)

Correspondence Address: Tsung Po YAO, P.O. Box 6-9 717, Tainan, TW

(21) Appl. No.: 11/326,743

(22) Filed: Jan. 6, 2006

(51) Int. Cl. A47J 42/00

(52) U.S. Cl. 241/169.1

(57) ABSTRACT

A flavoring container includes a main body, a grinding member, a knob and an outer shell. The main body is composed of a bottom cylinder and a sleeve. The bottom cylinder is provided with a locking projection located at an outer upper portion. The sleeve is provided with an outer matching member at the lower portion provided with a locking recess in the inner surface. The outer shell can be fixed in a fixing groove of the bottom cylinder. The sleeve is put inside the outer shell from the top and then, fixed together with the bottom cylinder via locking the locking projection with the locking recess, enabling the outer shell to be restricted between the bottom cylinder and the sleeve. Finally, the grinding member and the knob are assembled together orderly.

### BACKGROUND OF THE INVENTION

1. Field of the Invention

This invention relates to a flavoring container, particularly to one provided with an outer shell, fixed between a bottom cylinder and a sleeve of a main body, assembled with a grinding member to become practical and alterable.

2. Description of the Prior Art

As shown in FIG. 1, a conventional flavoring container is usually formed by an integral mold with a single material, so it not only wastes material and has a heavy shell, but also can be only shaped as simple as quadrate or circular, unable to formed into various shapes; moreover, one mold can only produce a single shape without possibility to make its components combined with one another. Therefore, its material is restrictive to those easy to be shaped, such as glass or plastics. As for metals, though they are characterized by a shining and aesthetic appearance, they are very difficult to be manufactured owing to expensive or time-consuming factors. Moreover, a flavoring, such as salt, is to corrode the metallic container in a long-term contact, so metals are unusable for flavoring containers.

### SUMMARY OF THE INVENTION

The prime object of this invention is to offer a flavoring container with a low cost and a stable structure.

The main characteristics of the invention are a main body, a grinding, member, a knob and an outer shell. The main body is composed of a bottom cylinder and a sleeve. The bottom cylinder is provided with a locking projection located at an outer upper portion. The sleeve is provided with an outer matching member at the lower portion provided with a locking recess in the inner surface. The outer shell can be fixed in a fixing groove of the bottom cylinder. The sleeve is put inside the outer shell from the top and then fixed together with the bottom cylinder via locking the locking projection with the locking recess, enabling the outer shell to be restricted between the bottom cylinder and the sleeve. Finally, the grinding member and the knob are assembled orderly.

### BRIEF DESCRIPTION OF DRAWINGS

This invention is better understood by referring to the accompanying drawings, wherein:

FIG. 1 is a cross-sectional view of a conventional flavoring container;

FIG. 2 is a perspective view of a preferred embodiment of a flavoring container in the present invention;

FIG. 3 is an exploded perspective view of the preferred embodiment of a flavoring container in the present invention;

FIG. 4a is a cross-sectional view of the preferred embodiment of a flavoring container in the present invention; and,

FIG. 4b is a magnified view of the part marked (A) in FIG. 4a.

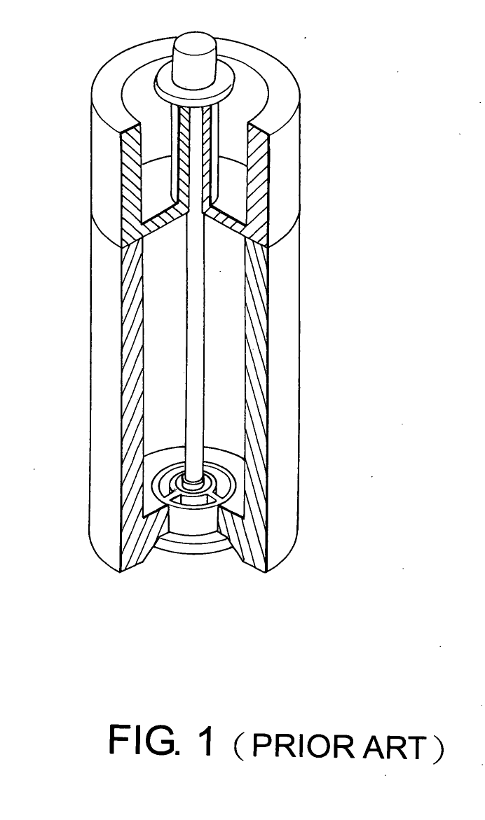

### DETAILED DESCRIPTION OF THE PREFERRED EMBODIMENT

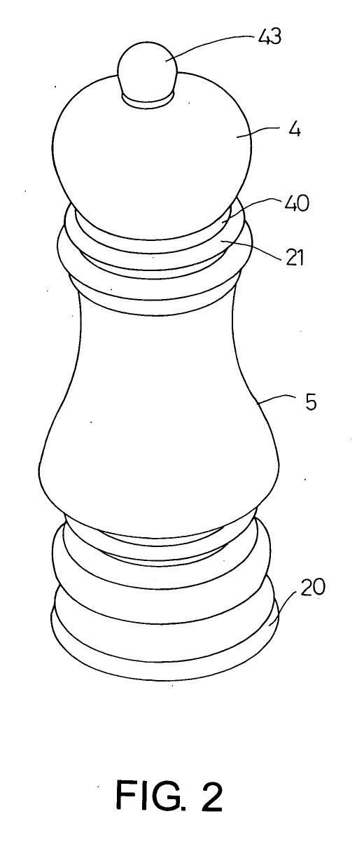

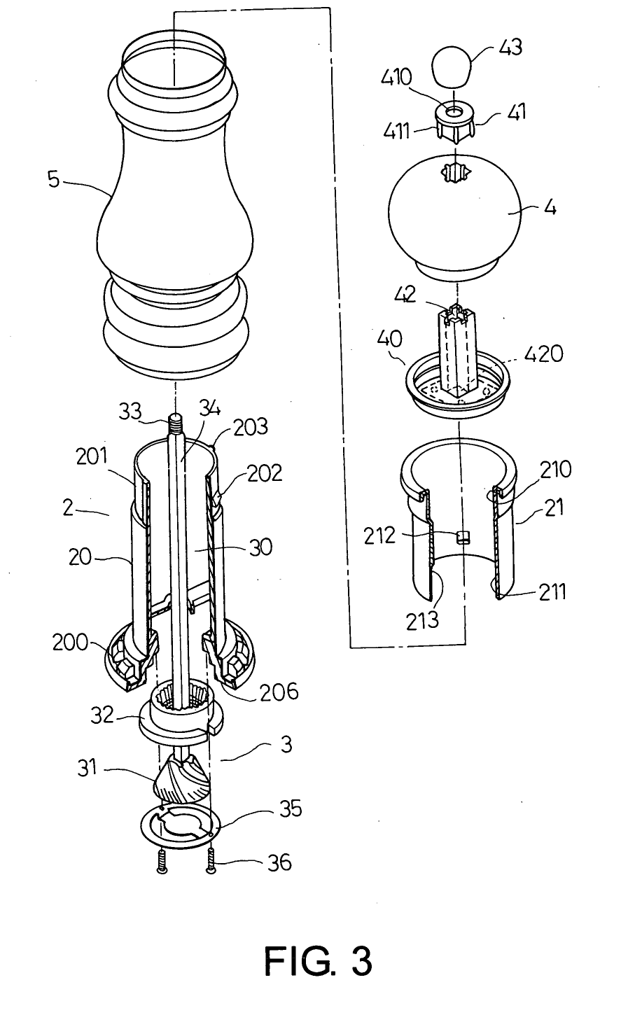

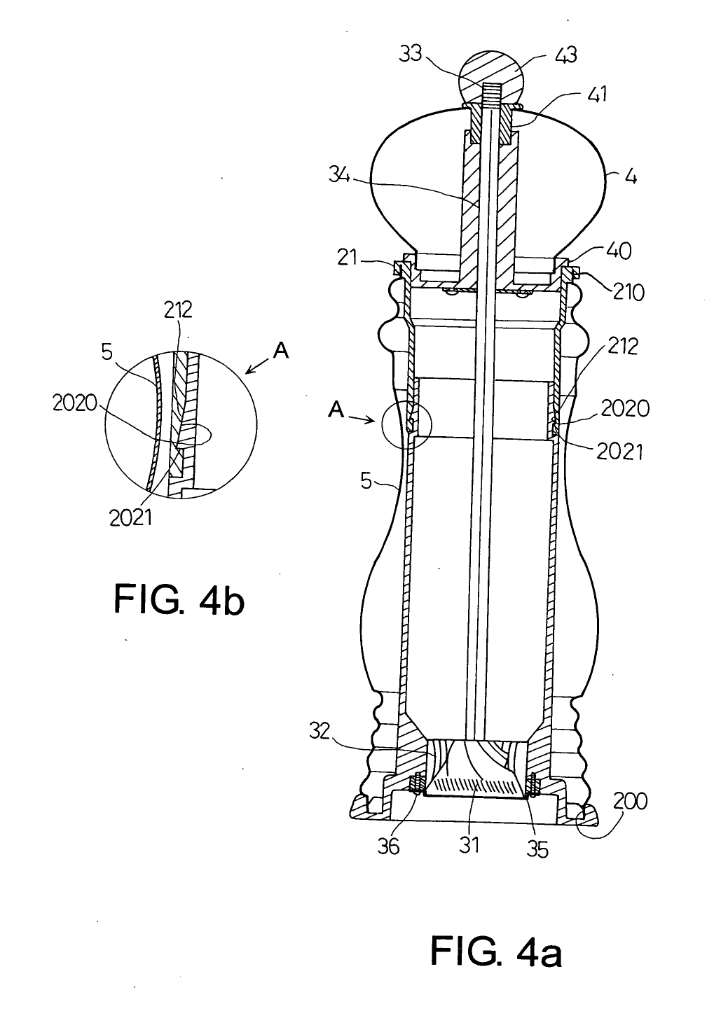

As shown in FIGS. 2, 3 and 4, a preferred embodiment of a flavoring container in the present invention includes a main body 2, a grinding member 3, a knob 4 and an outer shell 5.

The main body 2 is composed of a bottom cylinder 20 and a sleeve 21 that are made of non-toxic and non-metallic material. The bottom cylinder 20 is provided with a fixing groove 200 around its lower end, an inner matching member 201 at the upper portion provided with a locking projection 202 and a fixing ridge 203, a recess 204 at the bottom, two screw holes 205 cut symmetrically beside the recess 204 and an anti-slipping mat 206 under the bottom. The locking projection 202 has a sliding slope 2020 and a stopping surface 2021. The sleeve 21 is provided with a fixing groove 210 around the top and an outer matching member 211 at a lower portion provided with a locking recess 212 and a position groove 213.

The grinding member 3 is provided with a shaft 30, a grinding wheel 31 made of fine ceramics and a grinding ring 32 corresponding to the grinding wheel 31 at the lower end of the shaft 30. The shaft 30 is provided with threads 33 at the upper portion, a square column 34 below the thread 33, a position disc 35 under the grinding ring 32 and two screws 36 to be screwed in the screw holes 205 to fix up the position disc 35, enabling the grinding ring 32 to be fixed in the interior of the recess 204 of the bottom cylinder 20. The grinding wheel 31 can rotate against the grinding ring 32 when being driven by the shaft 30.

The knob 4 set above the main body 2 is provided with a linking member 40, a fixing ring 41 fitted in the top of the linking member 40. Both the linking member 40 and fixing ring 41 are made of non-metallic material. The linking member 40 used to cover on the top of the main body 2 after being fitted with the sleeve 21 is provided with a locking hole 42 and a square hole 420 at its central column. The fixing ring 41 is provided with a hole 410 at the center and plural locking ridges 411 spaced apart around the lower portion. When the square column 34 of the shaft 30 is fitted into the square hole 420 of the linking member 40 until it is locked with the locking hole 42, an ornamental member 43 can be screwed together with the thread 33 of the shaft 30, so that the grinding wheel 31 and the grinding ring 32 can rotate oppositely while the knob 4 is rotated.

The outer shell 5 inserted in the fixing groove 200 of the bottom cylinder 20 and the fixing groove 210 of the sleeve 21 is as long as the distance between the fixing groove 200 and the fixing groove 210, enabling it to be fitted together with the main body 2.

In assembling, the outer shell 5 is first fitted into the fixing groove 200 of the bottom cylinder 20. Next, put the sleeve 21 into the outer shell 5 through its top and keep the position groove 213 of the outer matching member 211 of the sleeve 21 matched with the fixing ridge 203 of the bottom cylinder 20. Then, press down the sleeve 21 to force the sliding slope 2020 of the locking projection 202 to slide into the locking recess 212 of the sleeve 21 and the stopping surface 2021 of the locking projection 202 to be locked with the inner surface of the locking recess 212. By the time, the upper and lower ends of the outer shell 5 are respectively fixed with the fixing groove 200 of the bottom cylinder 20 and the fixing groove 210 of the sleeve 21, enabling the outer figured shell 5 combined together with the main body 2. Next, put the grinding member 3 into the interior of the outer shell 5 from the bottom of the main body 2 and keep the grinding wheel 31 facing to the grinding ring 32. Then, attach the position disc 35 under the grinding wheel 31 and screw the screws 36 in the screw holes 205 so as to keep the grinding wheel 31 and the grinding ring 32 positioned at the bottom of the main body 2. The knob 4 is next put on the shaft 30 and pressed to keep the square hole 420 fully inserted by the square column 34 of the linking member 40. Finally, the ornamental member 43 is engaged with the threads 33 of the shaft 30.

The present invention has the following advantages as can be seen from the foresaid description.

1. It is very easy and convenient to combine the bottom cylinder 20 together with the sleeve 21 of the main body 2.

2. The length of the main body 2 and the size of the outer shell 5 can be altered dependent on different customers'requirements.

3. Because the fixing ridge 203 of the bottom cylinder 20 is matched with the position groove 213 of the sleeve 21 in advance while assembling, therefore, the locking projection 202 of the bottom cylinder 20 can be easily locked with the locking recess 212.

While the preferred embodiment of the invention has been described above, it will be recognized and understood that various modifications may be made therein and the appended claims are intended to cover all such modifications that may fall within the spirit and scope of the invention.

What is claimed is:

1. A flavoring container comprising:
a main body provided with a bottom cylinder and a sleeve;
a grinding member installed in the interior of said main body and provided with a shaft, a grinding wheel and a grinding ring; said grinding ring located at a lower end of said shaft and matched with said grinding wheel to stay at the bottom of said bottom cylinder; said shaft extended above said main body with its upper portion to screw with a knob;
said knob rotated to drive said grinding wheel to rotate against said grinding ring;
an outer shell enclosing said main body; and
said bottom cylinder provided with an inner matching member at an upper portion, said inner matching member provided with a locking projection; said sleeve provided with an outer matching member, said outer matching member provided with a locking recess for locking with said locking projection of said inner matching member, said outer shell thus able to be fixed tightly with said main body.

2. A flavoring container as claimed in claim 1, wherein said main body is made of a non-toxic and non-metallic material, provided with a fixing groove at one end of said bottom cylinder and said sleeve respectively for fixing with said outer shell.

3. A flavoring container as claimed in claim 1, wherein said knob is provided with a linking member and a fixing ring made of non-metallic material.

4. A flavoring container as claimed in claim 1, wherein the distance between each said fixing groove of said bottom cylinder and said sleeve is as long as the length of said outer shell so that said outer shell can be matched between said bottom vessel and said sleeve.

5. A flavoring container as claimed in claim 1, wherein the length of said main body and said outer figured shell is alterable, depending on different requirements.
